(19) United States
(12) Patent Application Publication
(10) Pub. No.: US 2016/0229222 A1
(43) Pub. Date: Aug. 11, 2016

(54) SYSTEMS AND METHODS OF PRODUCING IMAGES IN BAS RELIEF VIA A PRINTER

(71) Applicant: Alchemy Dimensional Graphics, LLC, Hillsborough, NC (US)

(72) Inventor: WILLIAM M. STECKER, Hillsborough, NC (US)

(21) Appl. No.: 14/616,072

(22) Filed: Feb. 6, 2015

(51) Int. Cl. B44C 1/18; B29C 67/00; G06T 3/00

(52) U.S. Cl. CPC B44C 1/18; G06T 3/00; B29C 67/0059; B29C 67/0088; B33Y 10/00

(57) ABSTRACT

A method of making a bas relief from a two-dimensional image includes converting a two-dimensional image to a grey-scale image that comprises a plurality of shades of grey. Each shade of grey corresponds to a respective elevation of a three dimensional representation of the two-dimensional image. Ink is deposited on a substrate via a printer to form a three-dimensional topography that corresponds to the three-dimensional representation of the two-dimensional image. The two-dimensional image is then printed, in accurate registration, onto the three-dimensional pattern to produce the bas relief. A protective coating and/or film may be applied to the three-dimensional pattern and image printed thereon.

### FIELD OF THE INVENTION

The present invention relates generally to decorative articles and, more particularly, to systems and methods of making decorative articles.

### BACKGROUND

The creation of an article with a low relief, three-dimensional image, also known as a bas relief, is conventionally performed by one of the following four methods. The first method involves creating an image by removing material from an article, for example, by sculpting. Alternatively, a machine may be employed to route, mill or laser away material leaving a desired three-dimensional topography. Duplication machinery, such as pantographs and multiple spindle machining centers can increase production rates, but are commercially limited to low volume production. The size of the resulting bas relief typically is limited by the dimensions of a duplication machine's operating range or bed size.

A second conventional method of producing a bas relief is via the use of a mold. Typically, a mold from which a bas relief is cast is made manually (e.g., by an artist). Molds are typically used in producing bas relief made from metal, clay, brick, and the like.

A third conventional method of producing a bas relief is via embossing. Embossing is a procedure where pressure is used to deform a material to create a three dimensional relief therein. This method may be used to produce bas relief in plastics, leather, cloth, sheet metal, clay, and the like.

A fourth conventional method of producing a bas relief is via direct deposition of polymer material on a surface, for example, under computer control. Polymer material may be applied as a liquid and dried or, alternatively, polymer material may be applied as a liquid and then polymerized (i.e., cured) with targeted energy.

Unfortunately, all of these conventional methods have cost and size limitations. In the case of direct creation, size may be limited by the machine used to remove material from an article to create a three dimensional topography. In the case of molding or embossing, the size of a bas relief is limited by the equipment involved. The cost of molds and embossing tools typically goes up exponentially as size increases, as does the size and cost of the machine necessary to employ the mold or embossing medium.

Three dimensional (3D) printing is a generic term used in the print industry and which refers to the use of layering to create dimension. 3D printing methodology is simply a process of running the same file or part thereof repeatedly to create a built up image. It is most typically used to create raised text and the like. Additionally, the term 3D printing is used to describe a process for creating complex objects by the buildup of layers based on 3D CAD (computer aided drawing) files (e.g., .STL or .OBJ files).

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the invention.

According to some embodiments of the present invention, a method of making a bas relief from a two-dimensional image includes converting the two-dimensional image (e.g., a black and white image or a color image) to a grey-scale image that comprises a plurality of shades of grey, wherein each shade of grey corresponds to a respective elevation of a three dimensional representation (i.e., three dimensional topography) of the two-dimensional image. For example, in some embodiments, the lightest shade of grey (i.e., white) may represent the lowest elevation of the three dimensional representation, and the darkest shade of grey (i.e., black) may represent the highest elevation of the three dimensional representation. Alternatively, in some embodiments, the lightest shade of grey (i.e., white) may represent the highest elevation of the three dimensional representation, and the darkest shade of grey (i.e., black) may represent the lowest elevation of the three dimensional representation. The shades of grey in between the lightest and darkest shades of grey correspond to respective different elevations between the highest and lowest elevations. To achieve this according to some embodiments of the present invention, the pixel invert selection is chosen in the printer software so that it will understand to print the heaviest concentration of ink where pixels in the image are the fewest.

The grey-scale image may be manipulated to adjust shades of grey therein to indicate desired elevations in the three-dimensional representation. For example, if it is desired that a certain portion of the grey-scale image have a higher elevation in the final bas relief, the portion may be adjusted to have, for example, a darker shade of grey in the situation where the darkest shade of grey (i.e., black) represents the highest elevation of the three dimensional representation. Alternatively, the portion may be adjusted to have, for example, a lighter shade of grey in the situation where the lightest shade of grey (i.e., white) represents the highest elevation of the three dimensional representation. Note that the term “grey” is used to denote relative pixel density. When building a three dimensional topography in accordance with embodiments of the present invention, the goal is to deposit as much ink as possible on each pixel. This may be achieved but increasing saturation values and using all available ink colors (cyan, magenta, yellow, key (black) (CYMK color model) plus white to target each pixel). When using colors other than white to build a three dimensional topography, a subsequent pass with white ink over the entire topography is necessary to provide for the full color image to be overprinted.

Ink, such as ultra-violet (UV) curable ink, is deposited on a substrate via a printer to form a three-dimensional topography or pattern that corresponds to the three-dimensional representation of the two-dimensional image. An exemplary printer is a flat-bed printer, and depositing the ink on the substrate to form the three-dimensional pattern includes depositing multiple, sequential layers of ink on the substrate via the printer. Each layer of ink may have a thickness of between about 0.0001 inch and about 0.01 inch. In some embodiments of the present invention, the ink may be a mono-chromatic ink, such as white, off-white, etc. As such, the three-dimensional topography has a uniform color throughout. However, embodiments of the present invention are not limited to a three-dimensional topography having a uniform color. Moreover, colors other than white and off-white may be utilized.

The two-dimensional image is then printed, in accurate registration, onto the three-dimensional pattern to produce the bas relief. If the two-dimensional image is a color image, the printing of the image onto the bas relief in exact registration provides color to the bas relief. Printing of the two-dimensional image may be performed via a flat-bed printer, for example.

In some embodiments, a protective coating may be applied to the three-dimensional pattern and image printed thereon. In some embodiments a protective film may be applied and fused onto the three-dimensional pattern and image printed thereon.

According to other embodiments of the present invention, a system for making a bas relief from a two-dimensional image includes a printer (e.g., a flat-bed printer), a processor, and a memory coupled to the processor. The memory stores instructions that, when executed by the processor, cause the processor to perform one or more of the following operations: convert a two-dimensional image to a grey-scale image that comprises a plurality of shades of grey, wherein each shade of grey corresponds to a respective elevation of a three dimensional representation of the two-dimensional image; adjust shades of grey in the grey-scale image to indicate desired elevations in the three-dimensional pattern (e.g., via image editing software, such as Photoshop® from Adobe Systems, Inc.); direct the printer to deposit ink on a substrate (e.g., in multiple, sequential layers) to form a three-dimensional pattern that corresponds to the three-dimensional representation of the two-dimensional image; and direct the printer to print, in accurate registration, the two-dimensional image onto the three-dimensional pattern.

In some embodiments of the present invention, the memory stores instructions that, when executed by the processor, cause the processor to apply at least one layer of mono-chromatic ink to at least one portion of the three-dimensional pattern prior to directing the printer to print the two-dimensional image onto the three-dimensional pattern.

In some embodiments of the present invention, the memory stores instructions that, when executed by the processor, cause the processor to direct the printer to apply a protective coating to the three-dimensional pattern and image printed thereon.

It is noted that aspects of the invention described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present invention are explained in detail below.

### BRIEF DESCRIPTION OF THE DRAWINGS

The accompanying drawings, which form a part of the specification, illustrate some exemplary embodiments. The drawings and description together serve to fully explain the exemplary embodiments. The patent or application file contains at least one drawing executed in color. Copies of this patent or patent application publication with color drawings will be provided by the Office upon request and payment of the necessary fee.

FIG. 1 is a flowchart of operations for making articles having three-dimensional relief, according to some embodiments of the present invention.

FIG. 2 illustrates an exemplary color graphic image displayed via a display of a computing device and that may be converted into a grey-scale image, according to some embodiments of the present invention.

FIG. 3 is a grey-scale image of the color graphic image of FIG. 2 displayed via a display of a computing device.

FIG. 4 illustrates the grey-scale image of FIG. 3 after modification wherein shades of grey in the image have been adjusted to modify desired elevations.

FIG. 5A illustrates a three-dimensional topography printed onto a substrate and that is representative of the modified grey-scale image of FIG. 4.

FIG. 5B is an enlarged portion of the three-dimensional topography of FIG. 5B.

FIG. 6 illustrates white ink printed over the three-dimensional topography of FIG. 5A and which provides a uniform white background onto which the original color image will be printed.

FIG. 7 illustrates the two-dimensional image of FIG. 2 printed onto the three-dimensional topography of FIG. 5A in exact registration.

FIG. 8 is a block diagram of an exemplary printer that may be used in accordance with embodiments of the present invention.

FIG. 9 is a block diagram that illustrates details of an exemplary processor and memory that may be used to acquire and manipulate images, and to control the printer of FIG. 8 in accordance with embodiments of the present invention.

### DETAILED DESCRIPTION

The present invention will now be described more fully hereinafter with reference to the accompanying figures, in which embodiments of the invention are shown. This invention may, however, be embodied in many different forms and should not be construed as limited to the embodiments set forth herein. Like numbers refer to like elements throughout. In the figures, certain components or features may be exaggerated for clarity, and broken lines may illustrate optional features or elements unless specified otherwise. In addition, the sequence of operations (or steps) is not limited to the order presented in the figures and/or claims unless specifically indicated otherwise. Features described with respect to one figure or embodiment can be associated with another embodiment or figure although not specifically described or shown as such.

It will be understood that when a feature or element is referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

It will be understood that although the terms first and second are used herein to describe various features or elements, these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The term “about”, as used herein with respect to a value or number, means that the value or number can vary by +/− twenty percent (20%).

The term “bas relief”, as used herein, refers to an article having three-dimensional topography projecting outwardly from a background

The term “image”, as used herein, means a visual representation of something, whether in black and white or in color, and includes any type of image acquired or created in any manner. An image may be created, copied and stored in electronic form, and can be, for example, a vector image file or a raster image file. A raster image is a digital image that is created (for example, taking a photograph) or captured (for example, scanning an existing photograph) as a set of samples of a given space. A raster image includes a grid of x and y coordinates on a display space. A raster image file identifies which of these coordinates to illuminate in monochrome or color values. A raster file is sometimes referred to as a bitmap file because the raster file contains information that is directly mapped to a display grid. Examples of raster image file types include, but are not limited to, BMP, TIFF, GIF, and JPEG files. Vector image files use geometrical elements, such as points, lines, curves, and shapes or polygon(s), to represent images in computer graphics. Vector image files are stored as mathematical expressions as opposed to raster image files which are stored as a series of mapped “dots”, also known as pixels. The terms “image” and “graphic image”, as used herein, are interchangeable

The terms “topography”, “three-dimensional topography”, “three-dimensional relief”, and “three-dimensional pattern, as used herein, are interchangeable.

Embodiments of the present invention are not to be confused with 3D printing. 3D printing is a stand alone process for creating complex objects by the buildup of layers based on three dimensional CAD files, not the targeting of grey scale pixels as disclosed herein. Embodiments of the present invention give a printer the ability to create a 3D topography and then to print a color object over the 3D topography in perfect registration with the 3D topography. Prior to the present invention, printers have not been used in this manner.

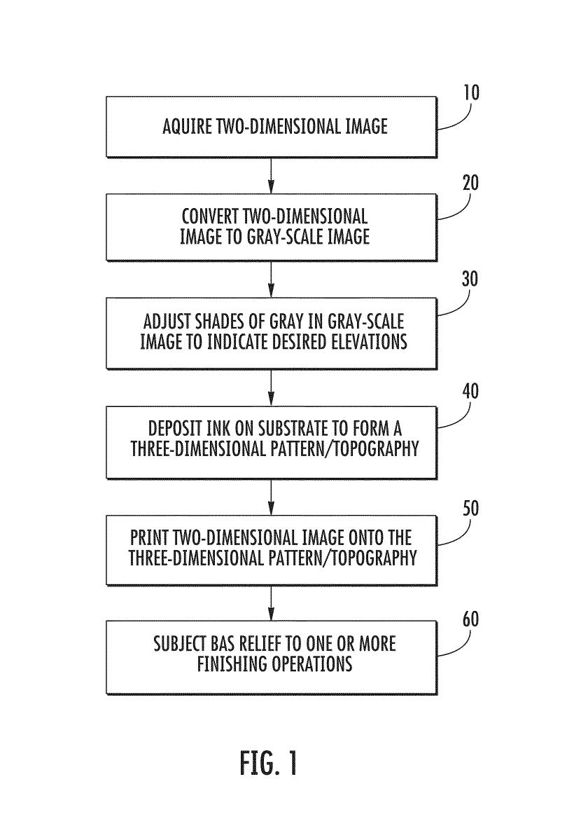

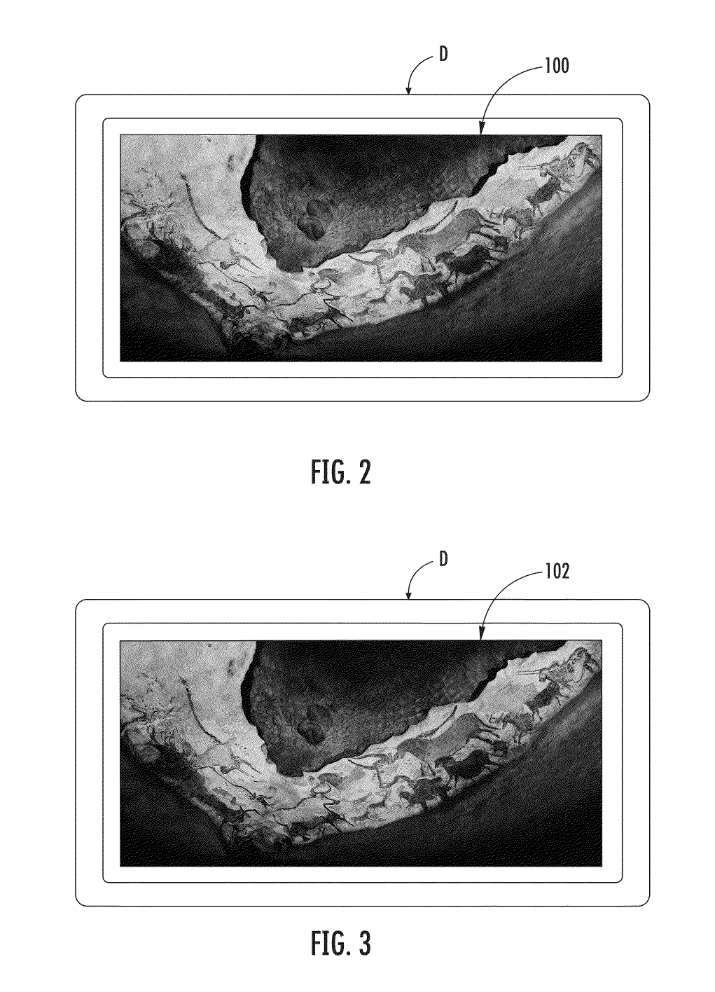

Referring now to the figures, methods of making decorative articles having printed and embossed surfaces, according to some embodiments of the present invention, will be described. Initially, a two-dimensional image is acquired (Block 10, FIG. 1). Any type of image may be utilized. For example, the image may be photographic image, an art work, a computer generated image, etc. The image may be originally digitized with a camera or may be converted to digital format via scanning. Next, the acquired two-dimensional image is converted into a two-dimensional grey-scale image (Block 20, FIG. 1), for example via a computing device/processor. FIG. 2 illustrates an acquired two-dimensional color image 100 displayed via a display D of a computing device and FIG. 3 is a grey-scale image 102 of the original image 100 of FIG. 2 displayed via the computing device display D.

The conversion of the acquired image 100 to a grey-scale image may be performed using any type of image editing program running on a computing device. An exemplary image editing program is Photoshop®, available from Adobe Systems, Inc., San Jose, Calif. However, various other image editing programs may be used without limitation. In the grey-scale image 102, which is similar to a black and white photograph, the grey value of each pixel will represent a respective elevation in a desired three-dimensional topography. For example, the darkest areas in the grey-scale image are areas which may represent the highest elevation in the three-dimensional relief, and the lightest areas may represent the lowest elevation areas in the three-dimensional relief. Alternatively, the lightest areas in the grey-scale image are areas which may represent the highest elevation in the three-dimensional relief, and the darkest areas may represent the lowest elevation areas in the three-dimensional relief. The shades of grey in between the lightest and darkest areas correspond to respective different elevations between the highest and lowest elevations.

The acquired image (100, FIG. 2) may undergo various detailed and/or artistic modifications via a processor/computing device prior to conversion to a grey-scale image. Similarly, the grey-scale image 102 may be subjected to various detailed and/or artistic modifications via a processor/computing device. In some embodiments, shades of grey in the grey-scale image 102 may be adjusted in one or more selected areas to indicate desired elevations in the three-dimensional topography. For example, if it is desired that a certain portion of the grey-scale image 102 have a higher elevation in the final bas relief, that portion may be adjusted to have, for example, a darker shade of grey in the situation where the darkest shade of grey (i.e., black) represents the highest elevation of the three dimensional representation. Alternatively, that portion may be adjusted to have, for example, a lighter shade of grey in the situation where the lightest shade of grey (i.e., white) represents the highest elevation of the three dimensional representation.

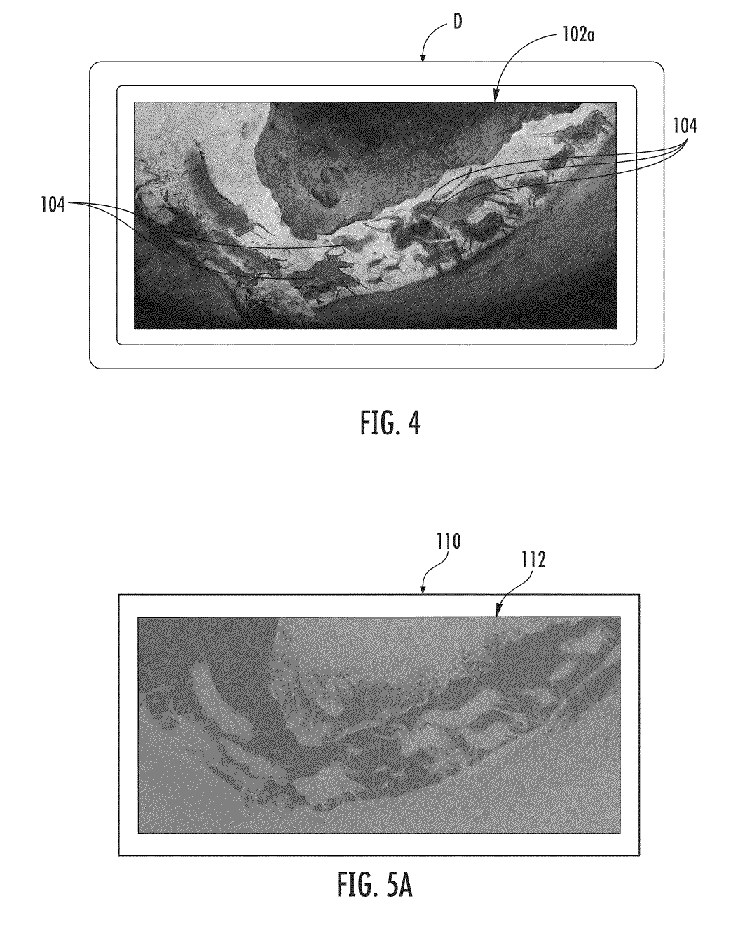

FIG. 4 illustrates an adjusted grey-scale image 102a displayed via the display D of a computing device and with selected areas 104 darkened. In the illustrated embodiment, the darkest areas in the grey-scale image 102 (and adjusted grey-scale image 102a) are areas which represent the highest elevation in the three-dimensional topography. The darkened selected areas 104, thus, are desired to have a higher elevation in the three-dimensional topography than in the grey-scale image 102.

In an alternative embodiment, a grey-scale image may be entirely computer generated based on pixels. For example, graphic artists may use digital tools such as “crops”, “brushes”, and “filters” to create and manipulate raster images. Thus, the grey-scale image 102 of FIG. 3 may be entirely computer generated.

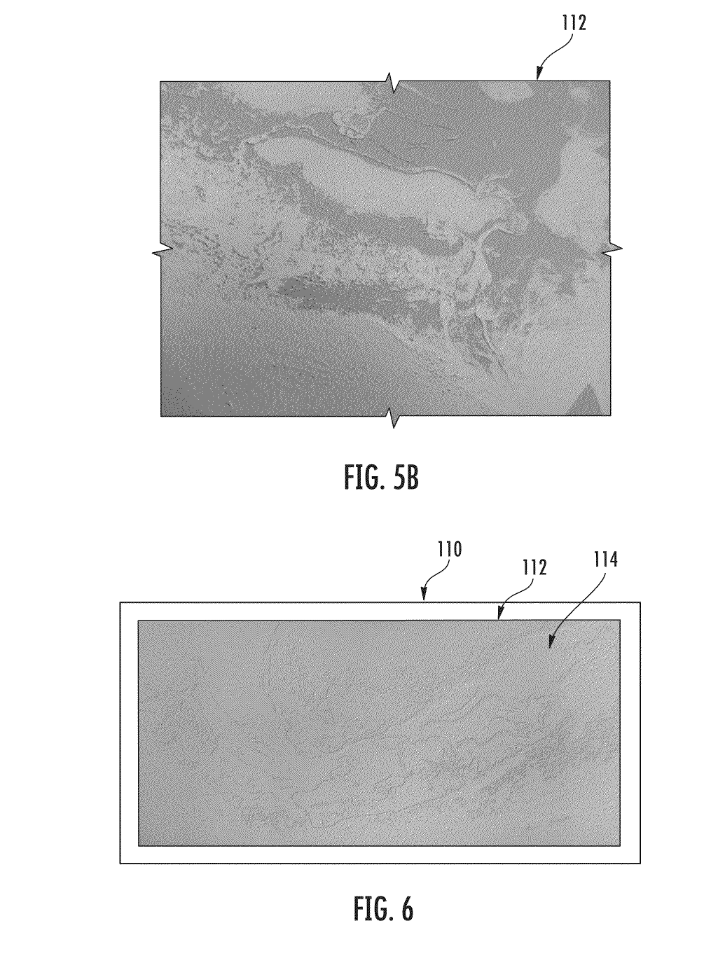

Ink, such as ultra-violet (UV) curable ink, is deposited on a substrate via a printer to form a three-dimensional pattern or topography that corresponds to the three-dimensional representation of the two-dimensional image (Block 40, FIG. 1). FIG. 5A illustrates a three-dimensional topography 112 that has been printed onto a substrate 110. The three-dimensional topography 112 is representative of the modified grey-scale image 102a of FIG. 4. The darkest areas in the modified grey-scale image 102a of FIG. 4 have the highest elevation in the three-dimensional topography 112. In the illustrated embodiment, the three-dimensional topography 112 is printed in layers of mono-chromatic ink. FIG. 5B is an enlarged portion of the three-dimensional topography 112 of FIG. 5A that illustrates the three-dimensional topography 112 in greater detail.

After the three-dimensional topography 112 is printed onto the substrate 110, the three-dimensional topography 112 is overprinted with white ink 114 via printer 200. Embodiments of the present invention are not limited to white ink. Ink having various other colors may be printed onto a three-dimensional topography, in accordance with embodiments of the present invention. This overprinting with white (or another color) ink provides a substantially uniform background upon which the original two dimensional image can be printed, as will be described below.

Substrates according to embodiments of the present invention can be formed from a variety of materials and can have virtually any size, shape and/or configuration. Exemplary substrate materials include, but are not limited to, metals, glass, polymeric materials, composite materials, foamed materials, wood, etc. Embodiments of the present invention are not limited to any particular type of substrate.

An exemplary printer that may be utilized in accordance with embodiments of the present invention is a flat-bed printer. FIG. 8 is a schematic illustration of an exemplary flat-bed printer 200 that may be utilized to deposit ink on a substrate 110 to form a three-dimensional topography, such as the three-dimensional topography 112 of FIGS. 5A-5B. The illustrated printer 202 includes movable ink dispensing heads 202, 204 for dispensing ink 206. Although two dispensing heads are illustrated in FIG. 8, it is understood that printers according to embodiments of the present invention may utilize different numbers of dispensing heads. For example, a printer may be utilized that has more than two dispensing heads, and may even have a single dispensing head. As the illustrated ink dispensing heads 202, 204 move in direction D1, droplets of ink 206 are dispensed to form multiple, sequential layers 208 on the substrate 110. Each ink layer 208 may have a thickness of between about 0.0001 inch and about 0.01 inch. The ink may be a mono-chromatic ink, such as white, off-white, etc., as illustrated in FIGS. 5A-5B.

The illustrated printer 200 also includes a curing or hardening system 210 which facilitates rapid curing of the ink 206. However, printers that may be utilized in accordance with embodiments of the present invention do not require a curing or hardening system 210.

Embodiments of the present invention are not limited to the illustrated printer 200 of FIG. 8. Various types of printers may be utilized in depositing multiple layers of ink so as to form three-dimensional topography in accordance with embodiments of the present invention. In addition, embodiments of the present invention are not limited to the use of ink. Other types of inkjettable materials that can be dispensed via a printer may be utilized, such as UV-curable polymers. The term “inkjettable materials” includes any type of materials that can be dispensed in multiple layers via a printer to form three-dimensional topography.

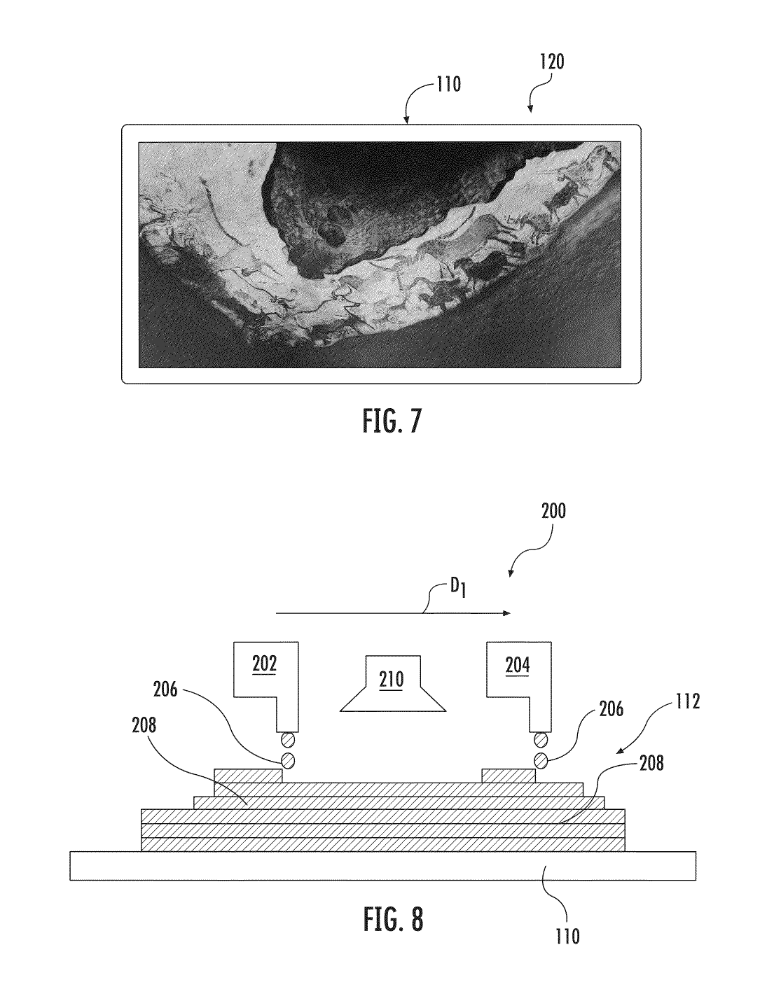

As illustrated in FIG. 7, the original two-dimensional image 100 is then printed, in accurate registration, onto the three-dimensional topography 112 (which has been overprinted with white ink) to produce the bas relief 120, for example, via printer 200. Because the two-dimensional image 100 is a color image, the printing of the image 100 onto the three-dimensional topography 112 in exact registration provides color to the bas relief 120.

The bas relief 120 may then be subjected to one or more finishing operations (Block 60, FIG. 1). For example, in some embodiments, a protective coating may be applied to the three-dimensional topography 112 and image 100 printed thereon. In some embodiments a protective film may be applied and fused onto the three-dimensional pattern 112 and image 100 printed thereon. A protective coating and/or film may be applied by the printer 200 or via another device.

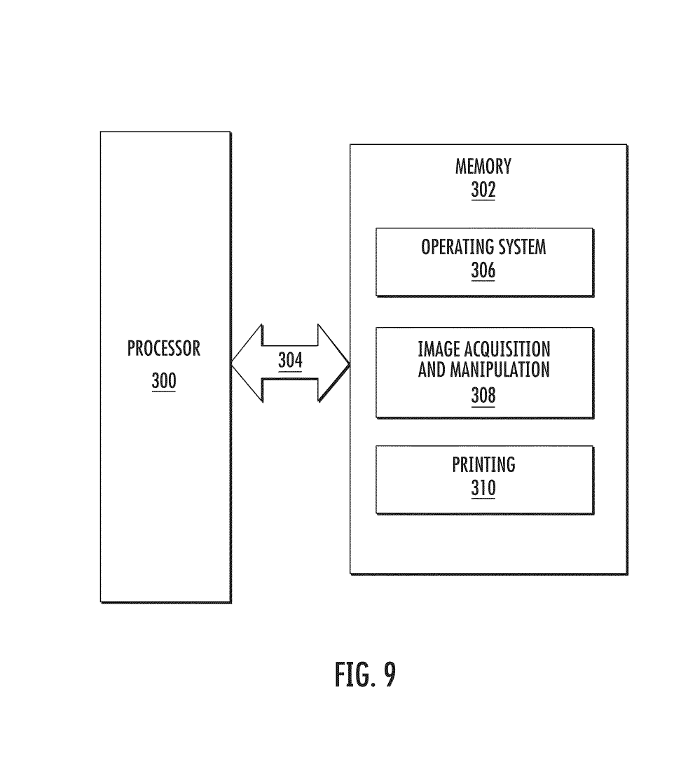

FIG. 9 illustrates an exemplary processor 300 and memory 302 that may be used in accordance with embodiments of the present invention. The processor 300 and memory 302 may be utilized to acquire and/or manipulate images and may also be utilized to control a printer to form a bas relief (e.g., 120, FIG. 7) as described above. The processor 300 communicates with the memory 302 via an address/data bus 304. The processor 300 may be, for example, a commercially available or custom microprocessor or similar data processing device. The memory 302 is representative of the overall hierarchy of memory devices containing the software and data used to perform the various operations described herein. The memory 302 may include, but is not limited to, the following types of devices: cache, ROM, PROM, EPROM, EEPROM, flash, SRAM, and DRAM.

As shown in FIG. 9, the memory 302 may hold various categories of software and data: an operating system 306, an image acquisition and manipulation module 308, and a printing module 310. The image acquisition and manipulation module 308 comprises logic for acquiring an image from any source, as well as for creating an image. In addition, the image acquisition and manipulation module 308 comprises logic for manipulating an image as described above (e.g., converting an image to a grey-scale image, adjusting shades of grey in the grey-scale image, etc.). The printing module 310 comprises logic for controlling the printer 200 of FIG. 8. Embodiments of the present invention are not limited to a single processor and memory. Multiple processors and/or memory may be utilized, as would be understood by those skilled in the art.

### Example

A high resolution digital color image of the cave art from Lascaux, France (e.g., FIG. 2) is opened in Adobe Photoshop®. The image is sized to desired product dimensions. A color image is saved, becoming file #1. The image is then converted to grey scale. The grey scale image is then manipulated with software tools including the pen tool, brush tool, invert function, etc., with the goal of changing the image such that areas which depict objects or backgrounds are made darker or lighter. A graphic artist creates darker areas corresponding to areas which the graphic artist wishes to be taller in the desired 3D topography, and lighter areas which are desired to be lower in the 3D topography. Certain areas of the grey scale image are “self-sorting” and do not require changing. Other areas, such as those which correspond to dark shadows in the image, are systematically lightened so they do not appear in the desired 3D topography as “objects”. On the other hand, light colored objects in the grey scale image which the artist wants to make taller in the 3D topography are made darker with the use of the appropriate software tools. The “enhanced” grey scale file is saved as file #2. Grey scale is at this time a function of pixel density with black pixels on a white background. Dark areas have pixels close together; lighter areas further apart.

File #2 is then opened in a print management software, such as Color Gate print management software, which will create the RIP (raster image processing) which will give print instructions to a flat bed digital printer, such as a Fuji Acuity 8 head flat bed digital printer. Print inks used with this printer are cured as they are deposited by UV curing lights. A polystyrene substrate is placed on the bed of the printer. The printer has 1 black print head, 1 yellow print head, 2 magenta print heads, 2 cyan print heads and 2 white print heads. Pixel mode is selected which will cause the printer to concentrate selected inks (CYMK, white) on a pixel by pixel basis. Color management function is set to deliver the maximum amount of ink from all 8 heads to each pixel in the image. Maximum ink delivery is limited by the ability of the UV curing lights to fully cure the deposited inks. (UV light cannot deeply penetrate opaque ink.) Under print options in the control software the CYMK-white-white output function is selected. All eight heads under this function selection will “fire” at every pixel of the grey scale image being processed. A 3D topography results from the buildup of ink.

The surface is now a 3D topography off white in color. The color results from the order in which the heads fired; CYMK first; white second. This print process may be repeated to achieve desired amount of relief.

The polystyrene substrate with the 3D topography is left in place on the printer. File #1 is now opened in the Color Gate software. White-white CYMK mode is selected in printer options. The printer then lays down 2 layers of white ink followed by the full color pattern of the desired image. The resulting image is now dimensionalized. A protective coating may then be applied by a separate device or in situ if the printer is equipped with a clear ink option.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the teachings and advantages of this invention. Accordingly, all such modifications are intended to be included within the scope of this invention as defined in the claims. The invention is defined by the following claims, with equivalents of the claims to be included therein.

That which is claimed is:

1. A method of making a bas relief from a two-dimensional image, the method comprising:
converting a two-dimensional image to a grey-scale image that comprises a plurality of shades of grey, wherein each shade of grey corresponds to a respective elevation of a three dimensional representation of the two-dimensional image;
depositing ink on a substrate via a printer to form a three-dimensional pattern that corresponds to the three-dimensional representation of the two-dimensional image; and
printing, in accurate registration, the two-dimensional image onto the three-dimensional pattern via the printer.

2. The method of claim 1, further comprising adjusting shades of grey in the grey-scale image to indicate desired elevations in the three-dimensional pattern prior to depositing ink on the substrate.

3. The method of claim 1, wherein depositing ink on the substrate to form the three-dimensional pattern comprises depositing multiple, sequential layers of ink on the substrate via the printer.

4. The method of claim 1, wherein depositing ink on the substrate to form the three-dimensional pattern comprises depositing mono-chromatic ink on the substrate via the printer.

5. The method of claim 3, wherein each layer of ink has a thickness between about 0.0001 inch and about 0.01 inch.

6. The method of claim 1, further comprising applying at least one layer of monochrome ink to at least one portion of the three-dimensional pattern prior to printing the two-dimensional image onto the three-dimensional pattern.

7. The method of claim 1, wherein the lightest shade of grey represents a lowest elevation of the three dimensional representation, wherein the darkest shade of grey represents a highest elevation of the three dimensional representation, and wherein shades of grey in between the lightest and darkest shades of grey correspond to respective different elevations between the highest and lowest elevations.

8. The method of claim 1, wherein the darkest shade of grey represents a lowest elevation of the three dimensional representation, wherein the lightest shade of grey represents a highest elevation of the three dimensional representation, and wherein shades of grey in between the lightest and darkest shades of grey correspond to respective different elevations between the highest and lowest elevations.

9. The method of claim 1, wherein the printer is a flat-bed printer.

10. The method of claim 1, further comprising applying a protective coating and/or film to the three-dimensional pattern and image printed thereon.

11. The method of claim 1, wherein the ink is ultra-violet (UV) curable ink.

12. The method of claim 1, wherein the ink is curable via light from a light emitting diode (LED) light source.

13. The method of claim 1, wherein the two-dimensional image is a color image or a black and white image.

14. A system for making a bas relief from a two-dimensional image, the system comprising:
a printer;
a processor; and
a memory coupled to the processor, the memory storing instructions that, when executed by the processor, cause the processor to:
convert a two-dimensional image to a grey-scale image that comprises a plurality of shades of grey, wherein each shade of grey corresponds to a respective elevation of a three dimensional representation of the two-dimensional image;
direct the printer to deposit ink on a substrate to form a three-dimensional pattern that corresponds to the three-dimensional representation of the two-dimensional image; and
direct the printer to print, in accurate registration, the two-dimensional image onto the three-dimensional pattern.

15. The system of claim 14, wherein the memory stores instructions that, when executed by the processor, cause the processor to direct the printer to deposit multiple, sequential layers of ink on the substrate to form the three-dimensional pattern.

16. The system of claim 14, wherein the memory stores instructions that, when executed by the processor, cause the processor to apply at least one layer of monochrome ink to at least one portion of the three-dimensional pattern prior to directing the printer to print the two-dimensional image onto the three-dimensional pattern.

17. The system of claim 14, wherein the lightest shade of grey represents a lowest elevation of the three dimensional representation, wherein the darkest shade of grey represents a highest elevation of the three dimensional representation, and wherein shades of grey in between the lightest and darkest shades of grey correspond to respective different elevations between the highest and lowest elevations.

18. The system of claim 14, wherein the darkest shade of grey represents a lowest elevation of the three dimensional representation, wherein the lightest shade of grey represents a highest elevation of the three dimensional representation, and wherein shades of grey in between the lightest and darkest shades of grey correspond to respective different elevations between the highest and lowest elevations.

19. The system of claim 14, wherein the printer is a flat-bed printer.

20. The system of claim 14, wherein the memory stores instructions that, when executed by the processor, cause the processor to direct the printer to apply a protective coating to the three-dimensional pattern and image printed thereon.
